(19) United States
(12) Patent Application Publication
(10) Pub. No.: US 2021/0080785 A1
(43) Pub. Date: Mar. 18, 2021

(54) BACKLIGHT MODULE

(71) Applicant: WUHAN CHINA STAR OPTOELECTRONICS TECHNOLOGY CO., LTD., Wuhan, Hubei (CN)

(72) Inventor: Yong YANG, Wuhan (CN)

(21) Appl. No.: 16/630,486

(22) PCT Filed: Nov. 13, 2019
(86) PCT No.: PCT/CN2019/118035

§ 371 Date: Jan. 13, 2020

(30) Foreign Application Priority Data
Sep. 12, 2019 (CN) 201910861639.1

(51) Int. Cl. G02F 1/13357

(52) U.S. Cl. CPC G02F 1/133603; G02F 2001/133607; G02F 1/133606

(57) ABSTRACT

The present disclosure discloses a backlight module. The present disclosure reduces a luminance of a chip at a positive viewing angle by using a semi-transmissive membrane layer in a mini-LED structure, and increases the luminous intensity between chips, thereby improving uniformity of light-mixing of an entire surface structure of the mini-LED, such that a backlight module of an ultra-thin liquid crystal display panel is prepared.

### BACKGROUND OF INVENTION

### Field of Invention

The present disclosure belongs to a field of backlight technologies, and in particular, to a backlight module.

### Description of Prior Art

A mini light-emitting diode (mini-LED) has become a hot spot in the market and the focus of market attention due to many advantages such as light weight, power saving, well flexibility, high brightness, applicability on production of a full-screen display device with a narrow bezel and a display device of a high dynamic contrast, and so on.

However, due to a limitation of light-emitting angles of a chip and a limitation of the number of chips, a surface light source has a problem of uneven brightness on the entire surface. Uniform light-mixing can be achieved by adding a diffuser of a high haze, but the diffuser is easy to cause a decrease in the front luminance of the surface light source due to the low transmittance of the diffuser, and is therefore not conducive to realization of advantages of energy saving and power saving. If the mixing effect is improved by increasing a light-emitting angle of the chip, the increase in the light-emitting angle of the chip may also cause a decrease in a light-emitting efficiency of the chip, and an overall light energy utilization rate of the surface light source may also be deteriorated. In addition, if a surface microstructure process is used to achieve uniform light-mixing, not only production processes are increased, but also a production cost is increased, and stability of the processes is not mature, so it is not an ideal scheme for light-mixing.

In view of this, there is a need to propose a solution to the problems in the prior art.

### SUMMARY OF INVENTION

In order to solve the above problems, the present disclosure provides a backlight module, which reduces a luminance of a chip at a positive viewing angle by using a semi-transmissive membrane layer in a mini-LED structure, and increases the luminous intensity between chips, thereby improving uniformity of light-mixing of an entire surface structure of the mini-LED, such that a backlight module of an ultra-thin liquid crystal display panel is prepared.

An embodiment of the present disclosure provides a backlight module including a substrate; a chip layer disposed on the substrate; an sealant layer covering the substrate and the chip layer; and a semi-transmissive membrane layer disposed on the sealant layer, wherein the semi-transmissive membrane layer allows semi-transmission of blue light and allows full transmission of red and green light.

Further, the backlight module further includes: a diffusion layer disposed on the semi-transmissive membrane layer; and a brightening layer disposed on the diffusion layer.

Further, the brightening layer is a prism layer.

Further, the substrate includes any one of a flexible substrate and a printed circuit board.

Further, the chip layer includes a plurality of chips.

Further, the sealant layer is a fluorescent adhesive layer.

Further, the sealant layer is a transparent adhesive layer.

Further, when the sealant layer is a transparent adhesive layer, a quantum dot layer is disposed on the semi-transmissive membrane layer.

Further, the semi-transmissive membrane layer has a blue light transmittance of 30% to 70%.

Further, the semi-transmissive membrane layer has a red-green light transmittance of greater than 85%.

Compared with the prior art, an embodiment of the present disclosure reduces a luminance of a chip at a positive viewing angle by using a semi-transmissive membrane layer in a mini-LED structure, and increases the luminous intensity between chips, thereby improving uniformity of light-mixing of an entire surface structure of the mini-LED, such that a backlight module of an ultra-thin liquid crystal display panel is prepared.

### BRIEF DESCRIPTION OF DRAWINGS

FIG. 1 is a schematic structural diagram of a backlight module according to an embodiment of the present disclosure.

FIG. 2 is a schematic structural diagram of a backlight module according to another embodiment of the present disclosure.

FIG. 3a is a schematic diagram of a light-mixing principle of a backlight module without a semi-transmissive membrane layer according to an embodiment of the present disclosure.

FIG. 3b is a schematic diagram of a light-mixing principle of a backlight module with a semi-transmissive membrane layer according to an embodiment of the present disclosure.

### DETAILED DESCRIPTION OF PREFERRED EMBODIMENTS

The technical solutions in the embodiments of the present application will be clearly and completely described in the following with reference to the accompanying drawings in the embodiments. It is apparent that the described embodiments are only a part of the embodiments of the present application, and not all of them. All other embodiments obtained by a person skilled in the art based on the embodiments of the present application without creative efforts are within the scope of the present application.

The terms “first”, “second”, and “third”, etc. (if present) in the specification and claims of the present disclosure are used to distinguish similar objects, and are not necessarily used to describe a particular order or prioritization. It should be understood that the objects so described are interchangeable where appropriate. Moreover, the terms “comprising” and “having” and “the” and any synonym thereof, are intended to cover non-exclusive inclusions.

The drawings, which are discussed below, and the various embodiments used to describe the principles of the present disclosure are intended to be illustrative only and not to limit the scope of the disclosure. Those skilled in the art will appreciate that the principles of the present disclosure may be implemented in any suitably arranged system. Exemplary embodiments will be described in detail, examples of which are illustrated in the accompanying drawings. Further, a terminal according to an exemplary embodiment will be described in detail with reference to the accompanying drawings. The same reference numerals in the drawings denote the same elements.

The terminology used in the description herein is only used to describe specific embodiments, and it is not intended to show the concept of the invention. Expressions used in the singular encompasses the plural forms of expression unless the context clearly dictates otherwise. In the description of the present invention, it is to be understood that the terms such as “including”, “having” and “containing”, are intended to be illustrative of the possibilities of the features, the numbers, the steps, the acts, or combinations thereof disclosed in the present disclosure, and it is not intended to exclude the possibility that one or more other features, numbers, steps, acts, or combinations thereof may be added. The same reference numerals in the drawings denote the same parts.

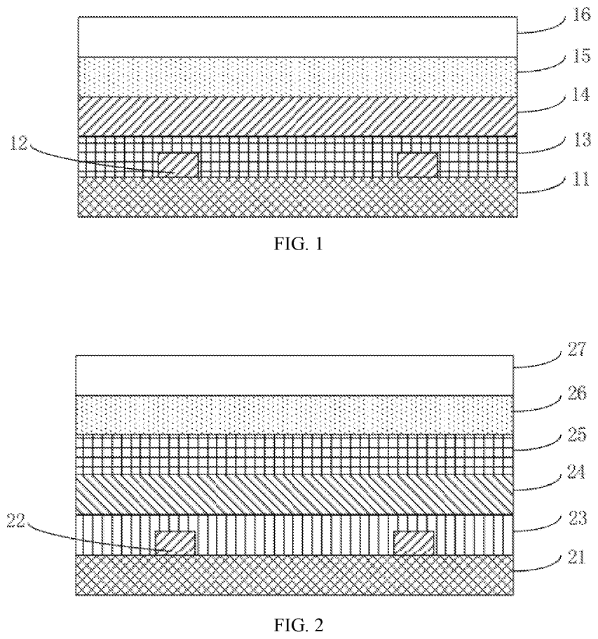

As shown in FIG. 1, an embodiment of the present disclosure provides a backlight module including a substrate 11, a chip layer 12, a sealant layer 13, a semi-transmissive membrane layer 14, a diffusion layer 15, and a brightening layer 16.

The substrate 11 may be a flexible printed circuit board (FPC) or a printed circuit board (PCB). The PCB can be selected from BT resin as a base material.

The chip layer 12 is provided on the substrate 11. The chip layer 12 includes a plurality of chips, and the chips may be mini-LED chips of a size of 100 micrometers to 500 micrometers. The chip is subjected to a surface die-bonding by a chip on board (COB) process.

The die-bonding is also called die-loading. The die-bonding is bonded to a designated area of a frame by a die-bonding adhesive to form a thermal path or an electrical path, which is a process for providing a condition for the subsequent wire bonding. The die-bonding adhesive comprises a conductive adhesive and an insulating adhesive. Specifically, the conductive adhesive may be a silver adhesive, and the insulating adhesive may be a transparent adhesive. The die-bonding adhesive has a film thickness of 0.1-0.15 mm, and mainly plays the role of fixing the chip.

The sealant layer 13 is disposed on the chip layer 12. The sealant layer 13 is a fluorescent adhesive layer having a thickness of 0.15-0.4 mm, and having a component comprising a phosphor and an optically clear adhesive (OCA). The optically clear adhesive and the phosphor are mixed to form a fluorescent adhesive. The fluorescent adhesive layer is formed by blanket coating, and a uniformity of the whole surface of the medium is great, so that after the light is emitted from the chip, the light is evenly transmitted in the fluorescent adhesive layer and not blocked, and the light at different angles on the surface of the adhesive layer is relatively uniform.

The semi-transmissive membrane layer 14 is disposed on the sealant layer 13. The semi-transmissive membrane layer 14 comprises a blue semi-transmissive membrane layer, which has a transmittance of more than 85%, for example, 90% to 98%, for a red-green light wavelength band of 500 nm to 780 nm and a light transmittance of 30%-70% for a blue light band of 80 nm to 500 nm, so that characteristics of allowing blue semi-transmission and red-green light full-transmission can be achieved, thereby weakening the luminous intensity in a direction of a positive viewing angle of the chip, and further improving the uniformity of light-mixing of an entire surface of the mini-LED. Accordingly, a backlight module for preparing an ultra-thin liquid crystal display panel can be prepared.

The diffusion layer 15 is provided on the semi-transmissive membrane layer 14. The diffusion layer 15 includes a diffusion sheet playing a role of light-uniformization and light-converging at a front view viewing angle. When the light passes through a diffusion sheet made of polyethylene terephthalate (PET) as a base material, the light passes through mediums having different refractive index, resulting in phenomenon of refraction, reflection, and scattering of light, such that it can correct the light into a uniform surface light source to achieve optical diffusion.

In the backlight structure, a main function of a diffusion sheet is to correct the diffusion angle, which increases an area of the light radiation, but reduces a light intensity per unit area, that is, reduces a luminance. After the light source is diffused by the diffusion material, it can become a secondary light source with a larger area, a better uniformity, and a stable chromaticity, and it has a function of diffusing light, that is, the light will scatter on its surface, and the light will be spread mildly and evenly. In addition, basic structures of most diffusion films are prepared by coating light-scattering particles on both sides of a transparent substrate such as PET.

The brightening layer 16 is provided on the diffusion layer 15. The brightening layer 16 includes a brightness enhancement film (BEF) playing a role of light-uniformization and light-converging at a front view viewing angle. A brightness enhancement film is an optical film formed by preparing a prism structure structure made of acrylic resin on a polyethylene terephthalate (PET) substrate by a microreplication technique, and the optical film has a microprism structure having a surface height of 20 μm to 50 μm. According to a principle of geometric optics, the light emitted by the backlight source is subjected to circulation of the prism film and the backlight system, and finally converges in the front viewing direction to achieve the brightening effect.

If the film is used in a backlight, when the light incident from the light source passes through the prism structure, only the incident light within a certain angular range can be emitted by refraction, and the remaining light is reflected back to the light source by an edge of the prism as failing to satisfy the refractive condition, and then re-emitted by the reflection sheet at a bottom of the light source. In this way, the light in the backlight is continuously recycled under an action of the prism structure, and the light originally scattering in various directions is controlled to converge within a range of 70° after passing through the brightness enhancement film, thereby achieving brightness enhancement effect in the front viewing direction. An effective transmission rate is increased by about 60% by a single sheet of the BEF series brightness enhancement film.

As shown in FIG. 2, the embodiment of the present disclosure provides a backlight module including a substrate 21, a chip layer 22, a sealant layer 23, a semi-transmissive membrane layer 24, a quantum dot layer 25, a diffusion layer 26, and a brightening layer 27.

The substrate 21 may be a flexible printed circuit board (FPC) or a printed circuit board (PCB). The PCB can be selected from BT resin as a base material.

The chip layer 22 is provided on the substrate 21. The chip layer 22 includes a plurality of chips, and the chips may be mini-LED chips of a size of 100 micrometers to 500 micrometers. The chip is subjected to a surface die-bonding by a chip on board (COB) process.

The die-bonding is also called die-loading. The die-bonding is bonded to a designated area of a frame by a die-bonding adhesive to form a thermal path or an electrical path, which is a process for providing a condition for the subsequent wire bonding. The die-bonding adhesive comprises a conductive adhesive and an insulating adhesive. Specifically, the conductive adhesive may be a silver adhesive, and the insulating adhesive may be a transparent adhesive. The die-bonding adhesive has a film thickness of 0.1-0.15 mm, and mainly plays the role of fixing the chip.

The sealant layer 23 is disposed on the chip layer 22. The sealant layer 23 is a fluorescent adhesive layer having a thickness of 0.15-0.4 mm, and having a component comprising a phosphor and an optically clear adhesive (OCA). The optically clear adhesive and the phosphor are mixed to form a fluorescent adhesive. The fluorescent adhesive layer is formed by blanket coating, and a uniformity of the whole surface of the medium is great, so that after the light is emitted from the chip, the light is evenly transmitted in the fluorescent adhesive layer and not blocked, and the light at different angles on the surface of the adhesive layer is relatively uniform.

The semi-transmissive membrane layer 24 is disposed on the sealant layer 23. The semi-transmissive membrane layer 24 comprises a blue semi-transmissive membrane layer, which has a transmittance of more than 85%, for example, 90% to 98%, for a red-green light wavelength band of 500 nm to 780 nm, and a light transmittance of 30%-70% for a blue light band of 80 nm to 500 nm, so that characteristics of allowing blue semi-transmission and red-green light full-transmission can be achieved, thereby weakening the luminous intensity in a direction of a positive viewing angle of the chip, and further improving the uniformity of light-mixing of an entire surface of the mini-LED. Accordingly, a backlight module for preparing an ultra-thin liquid crystal display panel can be prepared.

The quantum dot layer 25 is disposed on the semi-transmissive membrane layer 24 to function color conversion. The quantum dot layer 25 can convert part of the blue light into red-green light to form white mixed light. The so-called quantum dot (QD) technology is a semiconductor nanomaterial structure technology in which electrons are bound to a certain range, and the semiconductor nanomaterial structure is composed of ultra-small compound crystals having sizes of 1 to 100 nm. In the quantum dot technology, crystals of different sizes can be used to control a wavelength of light, thereby precisely controlling a color of light. Therefore, the quantum dot material is applied to the backlight module, and a high-frequency light source (for example, blue LED) is used to replace a traditional white LED light source. The quantum dot material can be excited to generate light of different wavelengths under irradiation of a high-frequency light source, and a color of the synthesized light can be adjusted to achieve backlighting requirements for a liquid crystal display of high color gamut (such as 100% NTSC) by adjusting sizes of the quantum dot material.

The diffusion layer 26 is provided on the quantum dot layer 25. The diffusion layer 26 includes a diffusion sheet playing a role of light-uniformization and light-converging at a front view viewing angle. When the light passes through a diffusion sheet made of polyethylene terephthalate (PET) as a base material, the light passes through mediums having different refractive index, resulting in phenomenon of refraction, reflection, and scattering of light, such that it can correct the light into a uniform surface light source to achieve optical diffusion.

In the backlight structure, a main function of a diffusion sheet is to correct the diffusion angle, which increases an area of the light radiation, but reduces a light intensity per unit area, that is, reduces a luminance. After the light source is diffused by the diffusion material, it can become a secondary light source with a larger area, a better uniformity, and a stable chromaticity, and it has a function of diffusing light, that is, the light will scatter on its surface, and the light will be spread mildly and evenly. In addition, basic structures of most diffusion films are prepared by coating light-scattering particles on both sides of a transparent substrate such as PET.

The brightening layer 27 is disposed on the diffusion layer 26. The brightening layer 27 includes a brightness enhancement film (BEF) playing a role of light-uniformization and light-converging at a front view viewing angle. A brightness enhancement film is an optical film formed by preparing a prism structure structure made of acrylic resin on a polyethylene terephthalate (PET) substrate by a microreplication technique, and the optical film has a microprism structure having a surface height of 20 μm to 50 μm. According to a principle of geometric optics, the light emitted by the backlight source is subjected to circulation of the brightness enhancement film and the backlight system, and finally converges in the front viewing direction to achieve the brightening effect.

If the film is used in a backlight, when the light incident from the light source passes through the prism structure, only the incident light within a certain angular range can be emitted by refraction, and the remaining light is reflected back to the light source by an edge of the prism as failing to satisfy the refractive condition, and then re-emitted by the reflection sheet at a bottom of the light source. In this way, the light in the backlight is continuously recycled under an action of the prism structure, and the light originally scattering in various directions is controlled to converge within a range of 70° after passing through the brightness enhancement film, thereby achieving brightness enhancement effect in the front viewing direction. According to the test, an effective transmission rate is increased by about 60% by a single sheet of the BEF series brightness enhancement film.

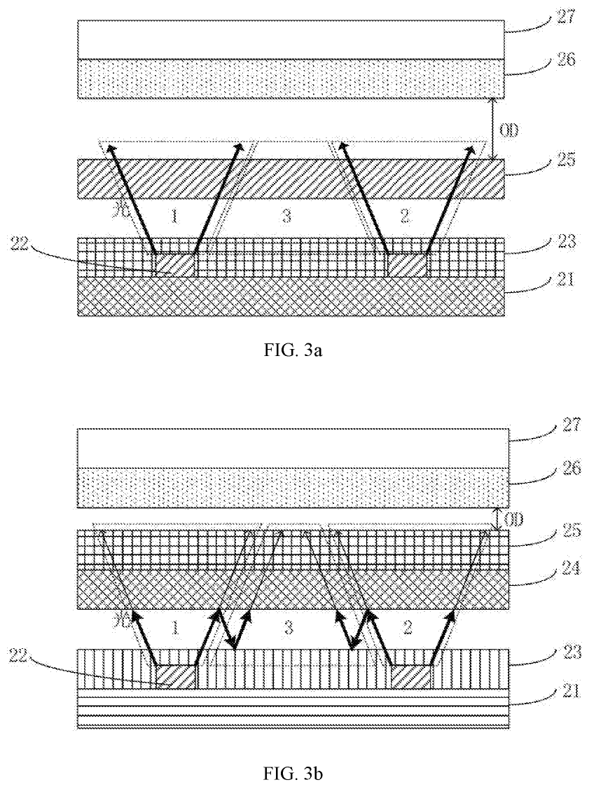

As shown in FIG. 3a, FIG. 3a is a schematic diagram showing a backlight module without a semi-transmissive membrane layer 24. The chip emits light upward at a certain angle. In FIG. 3a, brightness of the Area 1 and the Area 2 is higher, while brightness of the Area 3 is lower, and the Area 3 of the front view is prone to uneven brightness and darkness, commonly known as gray level mura, mainly due to a weak light intensity between chips, so that light-mixing of such an architecture requires a larger optical distance (OD), as shown in FIG. 3a.

As shown in FIG. 3b, FIG. 3b is a schematic diagram showing a backlight module with a semi-transmissive membrane layer 24. When a semi-transmissive membrane layer is adopted, the chip emits light upward at a certain angle, and part of the light is transmitted at the Area 1 and the Area 2, while part of the light is reflected. After the reflected light passes through a high reflectivity material on the substrate, the light is emitted at the Area 3 with a certain transmittance, so that the light is uniformly emitted at different points of the blue semi-transmissive membrane layer (the uniformity of the light emission of the Area 1, Area 2, and Area 3 is improved), and the gray mura phenomenon shown in FIG. 3a is eliminated, such that a smaller OD is required to achieve uniform light-mixing, which in turn makes the mini-LED backlight module thinner. The transmittance of the semi-transmissive membrane layer in the blue light band can be adjusted according to the reflectivity of the substrate material, such that uniform light-mixing of an entire surface of the mini-LED lamp plate can be realized.

An embodiment of the present disclosure reduces a luminance of a chip at a positive viewing angle by using a semi-transmissive membrane layer in a mini-LED structure, and increases the luminous intensity between chips, thereby improving uniformity of light-mixing of an entire surface structure of the mini-LED, such that a backlight module of an ultra-thin liquid crystal display panel is prepared.

The foregoing is a detailed description of a backlight module provided by the embodiments of the present disclosure. The principles and implementations of the present disclosure are described herein by using specific examples. The description of the above embodiments is only for helping to understand the method of the present disclosure, and the core concept. Also, those skilled in the art may make some changes in the specific implementation and application scope without departing from the concept of the present disclosure. In summary, the content of the present specification should not be construed as limiting the disclosure.

A subject matter of the present application can be manufactured and used in industry with industrial applicability.

1. A backlight module, comprising:
a substrate;
a chip layer disposed on the substrate;
a sealant layer covering the substrate and the chip layer;
a semi-transmissive membrane layer disposed on the sealant layer, wherein the semi-transmissive membrane layer allows semi-transmission of blue light and allows full transmission of red and green light; and
a quantum dot layer disposed on the semi-transmissive membrane layer.

2. The backlight module of claim 1, wherein the backlight module further comprises:
a diffusion layer disposed on the semi-transmissive membrane layer; and
a brightening layer disposed on the diffusion layer.

3. The backlight module of claim 2, wherein the brightening layer is a prism layer.

4. The backlight module of claim 1, wherein the substrate comprises any one of a flexible substrate and a printed circuit board.

5. The backlight module of claim 1, wherein the chip layer comprises a plurality of chips.

6. The backlight module of claim 1, wherein the sealant layer is a fluorescent adhesive layer.

7. The backlight module of claim 1, wherein the sealant layer is a transparent adhesive layer.

8. (canceled).

9. The backlight module of claim 1, wherein the semi-transmissive layer has a blue light transmittance of 30% to 70%.

10. The backlight module of claim 1, wherein the semi-transmissive layer has a red-green light transmittance of greater than 85%.
